(19) United States
(12) Patent Application Publication
(10) Pub. No.: US 2017/0003437 A1
(43) Pub. Date: Jan. 5, 2017

(54) COMPOSITE LIGHT GUIDE PLATE AND MANUFACTURING METHOD THEREOF, BACKLIGHT MODULE, AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Haijun SHI, Beijing (CN); Kai DIAO, Beijing (CN); Inho PARK, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/912,812

(22) PCT Filed: Aug. 3, 2015
(86) PCT No.: PCT/CN2015/085953

§ 371 Date: Feb. 18, 2016

(30) Foreign Application Priority Data
Mar. 3, 2015 (CN) 201510094694.4

(51) Int. Cl. F21V 8/00; B29C 35/08; B29D 11/00

(52) U.S. Cl. CPC G02B 6/0055; G02B 6/0065; B29D 11/00663; B29D 11/00875; B29C 35/0805; B29C 2035/0827; B29K 2067/003

(57) ABSTRACT

The present disclosure provides a composite light guide plate and a manufacturing method thereof, a backlight module and display device. The composite light guide plate includes a light guide plate body and a reflective film. Grid points are formed on a surface of one side of the light guide plate body, and the reflective film is arranged on the surface having the grid points of the light guide plate body and configured to reflect light beams reaching the reflective film towards a light-exiting face of the light guide plate body.

### CROSS-REFERENCE TO RELATED APPLICATION

The present application claims a priority to Chinese Patent Application No. 201510094694.4 filed on Mar. 3, 2015, the disclosure of which is incorporated in its entirety by reference herein.

### TECHNICAL FIELD

The present disclosure relates to the technical field of liquid crystal display, in particular, to a composite light guide plate and a manufacturing method thereof, a backlight module and a display device.

### BACKGROUND

A light guide plate is a main component of a backlight module and is configured to transform a point light source or a linear light source into a planar light source. The light guide plate may be applied in flat panel display devices such as liquid crystal displays, laptops, digital cameras, monitors and projectors, to provide a planar light source outputting with uniform luminance, such that the flat panel display devices can display images normally. Recently, a light emitting diode (LED) has become the light source of the light guide plate in the backlight module.

Generally, when assembling an existing backlight module, a reflective plate is arranged on a lower surface of the light guide plate. The reflective plate is configured to reflect light reaching the lower surface of the light guide plate towards an upper surface of the light guide plate, thereby avoiding light leakage from the lower surface of light guide plate and enhancing light utilization.

However, in the actual application, the backlight module still needs to be improved to enhance the light utilization and the display quality.

### SUMMARY

The present disclosure, which intends to solve at least one of the problems in conventional technologies, provides a composite light guide plate and a manufacturing method thereof, a backlight module and a display device. The composite light guide plate has a one-piece structure and has a reflection function; hence, the light reflection effect can be enhanced, it is easy to design a thin backlight module, and an assembling process for the backlight module and a structure of the backlight module are simplified. In addition, light utilization of the display device can be enhanced, it is easy to make the display device thin, and a structure of the display device and an assembling process for the display device are simplified. Furthermore, it is able to prevent a main body of light guide plate from being scratched and prevent a reflective plate from generating folds, thereby improving the display quality of the display device.

In one aspect, the present disclosure provides a composite light guide plate, including a light guide plate body and a reflective film. Grid points are formed on a surface of one side of the light guide plate body, and the reflective film is arranged on the surface having the grid points of the light guide plate body and configured to reflect light beams reaching the reflective film towards a light-exiting face of the light guide plate body.

Optionally, the reflective film is made of terephthalic acid based polymers.

Optionally, the reflective film is formed through a coating process.

Optionally, the light guide plate having the grid points on the surface of one side of the light guide plate is formed with a hot rolling-embossing process or an ejection process.

Optionally, the grid points are recesses or bulges formed on the surface of the light guide plate body.

Optionally, the reflective film completely covers the surface of the light guide plate body and exterior surfaces of the recesses or the bulges where the reflective film is arranged.

Optionally, an exterior surface of the reflective film is a plane.

In another aspect, the present disclosure further provides a backlight module including above composite light guide plate.

In still another aspect, the present disclosure further provides a display device including a display panel and above backlight module.

In yet another aspect, the present disclosure further provides a method for manufacturing a composite light guide plate, including: S1, manufacturing a light guide plate body, wherein grid points are formed on a surface of one side of the light guide plate body; and step S2, forming a reflective film on the surface having the grid points of the light guide plate body.

Optionally, the reflective film is formed through a coating process in step S2.

Optionally, the reflective film is made of terephthalic acid based polymers.

Optionally, after step S2, the method further includes step S3: curing the reflective film.

Optionally, the reflective film is cured by a curing process of ultraviolet radiation in step S3.

Optionally, in step S1, the light guide plate body whose surface is provided with the grid points is manufactured with a hot rolling-embossing process or an ejection process.

Optionally, the grid points are recesses or bulges formed on the surface of the light guide plate body.

Optionally, an exterior surface of the reflective film is a plane.

The present disclosure leads to the following beneficial effects.

In the composite light guide plate provided in the present disclosure, the reflective film is formed on the surface having the grid points of the light guide plate body. The reflective film is configured to reflect light beams reaching the reflective film towards the light-exiting face of the light guide plate body. In view of the above, the composite light guide plate provided in the present disclosure is of a one-piece structure, has a reflection function, and has the following advantages when compared with conventional technologies where the reflection function is realized by arranging a reflective plate onto the lower surface of the light guide plate body. Firstly, a gap between the reflective plate and the light guide plate body is avoided and partial light loss from the gap is avoided, thereby enhancing the reflection effect and improving the light utilization. Secondly, a thickness of the reflective film is generally small and smaller than a thickness of the conventional reflective plate; hence, with the thin composite light guide plate, a thin backlight module can be achieved while functions of the light guide plate body and the reflective plate in the conventional technologies can be achieved. Thirdly, since an adhesive force exists between the reflective film and the surface of the light guide plate body where the reflective film is arranged, the reflective film may not move with respect to the light guide plate body and contacting surfaces of the reflective film and the light guide plate body have no risk of being scratched, thereby improving the quality of an image displayed on the display panel. Fourthly, no matter whether the light guide plate body is warped, the reflective film is always attached on the surface of the light guide plate body and may not generate folds, thereby further improving the display quality of the display panel. Fifthly, the composite light guide plate has a one-piece structure; compared with a conventional assembly of the light guide plate body and the reflective plate, an assembling process for the backlight module and a structure of the backlight module are simplified.

The backlight module provided in the present disclosure includes the above light guide plate. Thus, light utilization of the backlight module can be enhanced. In addition, it is easy to make the backlight module thin, and both the structure and the assembling process are simplified.

The display deice provided in the present disclosure includes the above backlight module. Thus, light utilization of the display device can be enhanced. In addition, it is easy to make the display device thin, the display quality can be improved, and both the structure and the assembling process are simplified.

In the method for manufacturing the composite light guide plate provided in the present disclosure, the light guide plate body having the grid points on the surface of one side of the light guide plate body is manufactured in step S1; then, the reflective film is formed on the surface having the grid points in step S2. The reflective film is configured to reflect light beams reaching the reflective film towards a light-exiting face of the light guide plate body. With the manufacturing method, a composite light guide plate including a reflective film formed on a surface having grid points can be manufactured. The composite light guide plate is in a one-piece structure, has a reflection function, and has the following advantages when compared with conventional technologies where the reflection function is realized by arranging a reflective plate onto a lower surface of the light guide plate body. Firstly, a gap between the reflective plate and the light guide plate body is avoided and partial light loss from the gap is avoided, thereby enhancing the reflection effect and improving the light utilization. Secondly, a thickness of the reflective film is generally small and smaller than a thickness of the conventional reflective plate; hence, with the thin composite light guide plate, a thin backlight module can be achieved while functions of the light guide plate body and the reflective plate in the conventional technologies can be achieved. Thirdly, since an adhesive force exists between the reflective film and the surface of the light guide plate body where the reflective film is arranged, the reflective film may not move with respect to the light guide plate body and contacting surfaces of the reflective film and the light guide plate body have no risk of being scratched, thereby improving the quality of an image displayed on the display panel. Fourthly, no matter whether the light guide plate body is warped, the reflective film is always attached on the surface of the light guide plate body and may not generate folds, thereby further improving the display quality of the display panel. Fifthly, the composite light guide plate has a one-piece structure; compared with a conventional assembly of the light guide plate body and the reflective plate, an assembling process for the backlight module is simplified and a structure of the backlight module is simplified.

### BRIEF DESCRIPTION OF THE DRAWINGS

FIG. 1 is a sectional view of a composite light guide plate according to an embodiment of the present disclosure;

FIG. 2 is a sectional view of another composite light guide plate according to an embodiment of the present disclosure;

FIG. 3 is a sectional view of a portion of a backlight module according to an embodiment of the present disclosure;

FIG. 4 is a flow chart of a method for manufacturing a composite light guide plate according to an embodiment of the present disclosure; and;

FIG. 5 is a schematic diagram showing forming a reflective film by a coating process.

### REFERENCE LIST

10: composite light guide plate; 101: composite light guide plate body; 1011: grid points; 102: reflective film; 11: coating plate; 12: chamber.

### DETAILED DESCRIPTION OF THE EMBODIMENTS

For better understanding of aspects of the present disclosure by those skilled in the art, a composite light guide plate and a manufacturing method thereof, a backlight module and a display device provided in the present disclosure are described in detail hereinafter in conjunction with drawings. Exemplary embodiments are shown in the drawings, and same or similar references used throughout the drawings represent same or similar components or components having same or similar functions. The following embodiments described based on the drawings are exemplary, which are merely for explaining the present disclosure rather than for limiting the present disclosure.

It should be understood that in the description of the present disclosure, direction or location relationships indicated by terms such as “above/upper” and “below/lower” are direction or location relationships shown in the drawings. The use of the terms is merely for describing the present disclosure simply, and it is not indicated or implied that a related device or component should have a specific direction and location or should be constructed and operated with a specific direction and location, which are not limitations to the present disclosure.

FIG. 1 is a sectional view of a composite light guide plate according to an embodiment of the present disclosure. As shown in FIG. 1, the composite light guide plate 10 according to the embodiment includes a light guide plate body 101 and a reflective film 102. Grid points 1011 are formed on a surface of one side of the light guide plate body 101. As shown in FIG. 1, an upper surface of the light guide plate body 101 is a light-exiting face, that is, light beams are transmitted from the upper surface of the light guide plate body 101 towards a display panel. The grid points 1011 are arranged at a lower surface of the light guide plate body 101. Specifically, the grid points 1011 are recesses formed on the lower surface of the light guide plate body 101 and are configured to transmit light beams, which are emitted by a light source to the light guide plate body, towards the light-exiting face of the light guide plate body 101 in multiple paths. The light beams exiting from the upper surface of the light guide plate are finally transmitted along a direction perpendicular to the display panel after a series of processes, such that an image can be displayed on the display panel. The reflective film 102 is arranged on the surface having the grid points 1011 (i.e., the lower surface) of the light guide plate body 101 and is configured to reflect light beams reaching the reflective film 102 towards the upper surface of the light guide plate body 101.

In view of the above, the composite light guide plate provided in the present disclosure is in a one-piece structure, has a reflection function, and has the following advantages when compared with conventional technologies where the reflection function is realized by arranging a reflective plate onto the lower surface of the light guide plate body 101. Firstly, a gap between the reflective plate and the light guide plate body is avoided and partial light loss from the gap is avoided, thereby enhancing the reflection effect and improving the light utilization. Secondly, a thickness of the reflective film is generally small and smaller than a thickness of the conventional reflective plate; hence, with the above thin composite light guide plate, a thin backlight module can be achieved while functions of the light guide plate body and the reflective plate in the conventional technologies can be implemented. Thirdly, since an adhesive force exists between the reflective film and the surface of the light guide plate body where the reflective film is arranged, the reflective film may not move with respect to the light guide plate body and contacting surfaces of the reflective film and the light guide plate body have no risk of being scratched, thereby improving the display quality of the display panel. Fourthly, no matter whether the light guide plate body is warped, the reflective film is always attached on the surface of the light guide plate body and may not generate folds, thereby further improving the display quality of the display panel. Fifthly, the composite light guide plate has a one-piece structure; compared with a conventional assembly of the light guide plate body and the reflective plate, an assembling process for the backlight module is simplified and a structure of the backlight module is simplified.

In the embodiment, specifically, the reflective film 102 is made of terephthalic acid based polymers. In actual application, the reflective film 102 may also be made of other materials as long as the reflective film 102 can reflect light, where the materials are not enumerated herein.

In addition, the reflective film 102 may be formed by a coating process, which simplifies the process, reduces the cost and accordingly increases the economic benefit. Of course, in actual application, other ways can be used to form the reflective film 102 based on factors such as the material of the reflective film 102. For example, ways such as the physical vapor deposition or the chemical vapor deposition can be used to form the reflective film 102.

Optionally, the reflective film 102 completely covers the surface (i.e., the lower surface) of the light guide plate body 101 and exterior surfaces of the recesses (i.e., concave surfaces of the recesses themselves) where the reflective film 102 is arranged, such that the reflective film can prevent light loss thoroughly and light utilization can be enhanced greatly.

Further optionally, as shown in FIG. 1, an exterior surface (i.e., a lower surface) of the reflective film 102 is a plane, which is convenient for performing subsequent processes and assembling the backlight module.

In addition, in the embodiment, the light guide plate body 101 having the grid points 1011 on its surface is formed with a hot rolling-embossing process or an ejection process. The process of forming the light guide plate body 101 having the grid points 1011 on its surface with the hot rolling-embossing process or the ejection process is similar to the conventional technologies and is not detailed herein.

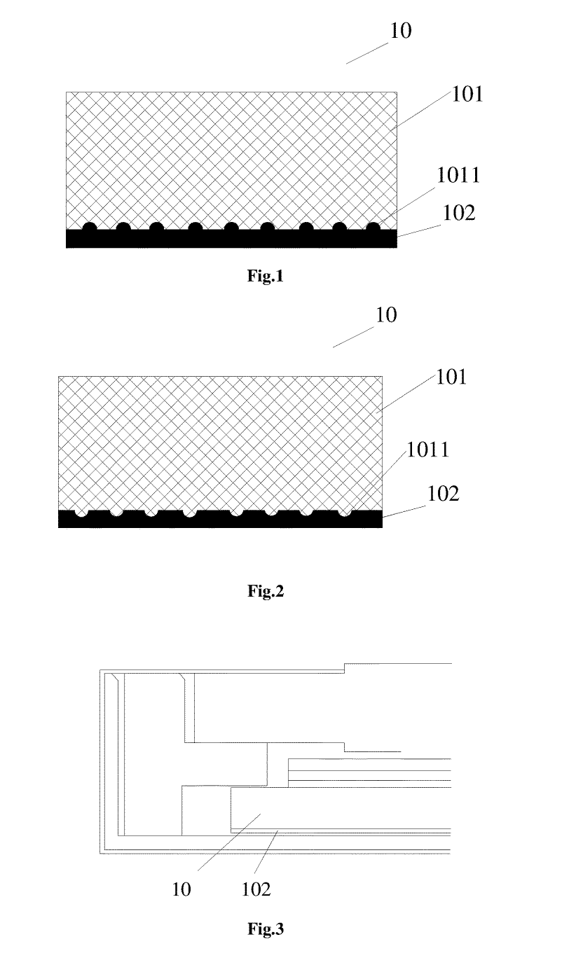

It should be noted that, although in the embodiment, the grid points 1011 are recesses formed on the surface of the light guide plate body 101, the present disclosure is not limited thereto. In actual application, the grid points 1011 can alternatively be bulges formed on the surface of the light guide plate body 101. In this case, similarly, the reflective film 102 may optionally cover the surface of the light guide plate body 101 and exterior surfaces of the bulges. In addition, an exterior surface (i.e., a lower surface) of the reflective film may optionally be a plane as shown in FIG. 2. Furthermore, the grid points 1011 may be all recesses or bulges, or some of the grid points 1011 are recesses while the others are bulges.

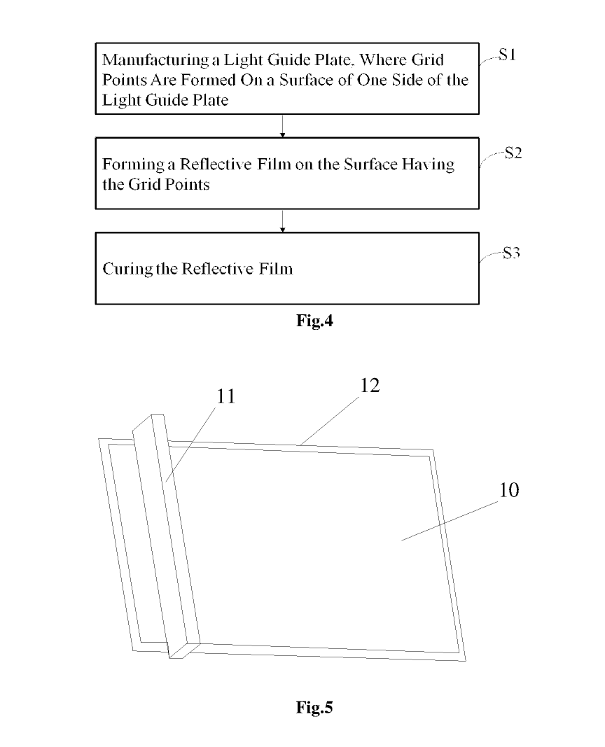

In another aspect, a backlight module is further provided in the present disclosure. As shown in FIG. 3, the backlight module includes the composite light guide plate 10 according to the previous embodiment of the present disclosure.

Specifically, the backlight module further includes a light source and a frame. The light source is configured to emit light, which is mainly a cold cathode fluorescent lamp (CCFL) or a light-emitting diode (LED). The CCFL is a tubular linear light source. The LED is a point light source. Accordingly, multiple LEDs are generally provided to ensure uniform luminance. The frame is for supporting the light source, the composite light guide plate, etc.

Since the backlight module includes the composite light guide plate according to the embodiment of the present disclosure, light utilization of the backlight module can be enhanced; in addition, it is easy to make the backlight module thin, and both the structure and the assembling process are simplified.

In still another aspect, a display device is provided in the present disclosure. The display device includes a backlight module according to the previous embodiment of the present disclosure, and a display panel.

Specifically, the display panel includes a liquid crystal display panel.

Since the display deice includes the backlight module according to the embodiment of the present disclosure, light utilization of the display device can be enhanced; in addition, it is easy to make the display device thin, the quality of a displayed image is improved, and both the structure and the assembling process are simplified.

In yet another aspect, a method for manufacturing a composite light guide plate is further provided in the present disclosure. FIG. 4 is a flow chart of a method for manufacturing a composite light guide plate according to an embodiment of the present disclosure. As shown in FIG. 4, the method for manufacturing the composite light guide plate according to the embodiment includes:

step S1: manufacturing a light guide plate body, wherein grid points are formed on a surface of one side of the light guide plate body; and

step S2: forming a reflective film on the surface having the grid points of the light guide plate body.

In step S1, the grid points are formed on a surface opposite to a light-exiting face of the light guide plate body. The grid points are configured to enable light beams emitted by a light source to the light guide plate body to be transmitted in multiple paths towards the light-exiting face of the light guide plate body. Specifically, the grid points are recesses or bulges formed on the surface of the light guide plate body.

In addition, specifically, the light guide plate body having the grid points on its surface is formed with a hot rolling-embossing process or an ejection process. The process of forming the light guide plate body having the grid points on its surface with the hot rolling-embossing process or the ejection process is similar to the conventional technologies and is not detailed herein.

Optionally, the reflective film completely covers the surface (i.e., the surface opposite to the light-exiting face) of the light guide plate body and exterior surfaces of the recesses or the bulges (i.e., concave surfaces of the recesses or convex surfaces of the bulges) where the reflective film is arranged, such that the reflective film can prevent light loss thoroughly and light utilization can be enhanced greatly.

Further optionally, as shown in FIG. 1 and FIG. 2, an exterior surface (i.e., a lower surface) of the reflective film is a plane, which is convenient for performing subsequent processes and assembling a backlight module.

In step S2, the reflective film is configured to reflect light beams reaching the reflective film towards the light-exiting face of the light guide plate body, thereby preventing light loss and improving light utilization. Specifically, in the embodiment, the reflective film is made of terephthalic acid based polymers. In actual application, the reflective film may be made of other materials as long as the reflective film can reflect light, where the materials are not enumerated here.

In addition, since a coating process is simple and of low input cost, in step S2, the reflective film is formed by the coating process to improve economic benefit. FIG. 5 is a schematic diagram showing forming a reflective film by the coating process. As shown in FIG. 5, in a chamber 12, a surface of a light guide plate body 10, where grid points are arranged, is a surface to be processed and is arranged towards a coating plate 11. The coating plate 11 moves from left to right, to form the reflective film on the surface of the light guide plate body 10 where the grid points are arranged.

It should be noted that, although in step S2 of the embodiment the reflective film is formed by the coating process, the disclosure is not limited thereto. In actual application, other ways can be used to form the reflective film based on factors such as the material of the reflective film. For example, ways such as the physical vapor deposition or the chemical vapor deposition can be used to form the reflective film.

Optionally, after step S2, the method further includes step S3: curing the reflective film, which is faster than self-curing and leads to improved curing efficiency and reduced process time.

Further optionally, in step S3, the reflective film is cured by a curing process of ultraviolet radiation to further improve the curing efficiency. In actual application, other processes can be applied to cure the reflective film to improve the curing efficiency and those processes are not enumerated here.

In view of the above, in the method for manufacturing the composite light guide plate according to the embodiment of the present disclosure, the light guide plate body having the grid points on the surface of one side of the light guide plate body is manufactured in step S1; then, the reflective film is formed on the surface having the grid points in step S2. The reflective film is set to reflect light beams reaching the reflective film towards a light-exiting face of the light guide plate body. With the manufacturing method, a composite light guide plate including a reflective film formed on a surface having grid points can be manufactured. The composite light guide plate (as shown in FIG. 1) is in a one-piece structure, has a reflection function, and has the following advantages when compared with conventional technologies where the reflection is realized function by arranging a reflective plate onto a lower surface of the light guide plate body. Firstly, a gap between the reflective plate and the light guide plate body is avoided and partial light loss from the gap is avoided, thereby enhancing the reflection effect and improving the light utilization. Secondly, a thickness of the reflective film is generally small and smaller than a thickness of the conventional reflective plate; hence, with the above thin composite light guide plate, a thin backlight module can be achieved while functions of the light guide plate body and the reflective plate in the conventional technologies can be implemented. Thirdly, since an adhesive force exists between the reflective film and the surface of the light guide plate body where the reflective film is arranged, the reflective film may not move with respect to the light guide plate body and contacting surfaces of the reflective film and the light guide plate body have no risk of being scratched, thereby improving the display quality of the display panel. Fourthly, no matter whether the light guide plate body is warped, the reflective film is always attached on the surface of the light guide plate body and may not generate folds, thereby further improving the quality of the image displayed on the display panel. Fifthly, the composite light guide plate has a one-piece structure; compared with a conventional assembly of the light guide plate body and the reflective plate, an assembling process for the backlight module is simplified and a structure of the backlight module is simplified.

It can be understood that, the above implementations are merely exemplary implementations for explaining the principle of the present disclosure, while the present disclosure is not limited thereto. The ordinary skilled in the art can make various modifications and improvements without departing from the mind and essence of the present disclosure, and those modifications and improvements will fall within the scope of protection of the present disclosure.

1. A composite light guide plate, comprising a light guide plate body and a reflective film; wherein
grid points are formed on a surface of one side of the light guide plate body, and the reflective film is arranged on the surface having the grid points of the light guide plate body and configured to reflect light beams reaching the reflective film towards a light-exiting face of the light guide plate body.

2. The composite light guide plate according to claim 1, wherein the reflective film is made of terephthalic acid based polymers.

3. The composite light guide plate according to claim 1, wherein the reflective film is formed through a coating process.

4. The composite light guide plate according to claim 1, wherein the light guide plate body having the grid points is formed with a hot rolling-embossing process or an ejection process.

5. The composite light guide plate according to claim 1, wherein the grid points are recesses or bulges formed on the surface of the light guide plate body.

6. The composite light guide plate according to claim 5, wherein the reflective film completely covers the surface of the light guide plate body and exterior surfaces of the recesses or the bulges where the reflective film is arranged.

7. The composite light guide plate according to claim 1, wherein an exterior surface of the reflective film is a plane.

8. A backlight module, comprising the composite light guide plate according to claim 1.

9. A display device, comprising the backlight module according to claim 8 and a display panel.

10. A method for manufacturing a composite light guide plate, comprising:
step S1, manufacturing a light guide plate body, wherein grid points are formed on a surface of one side of the light guide plate body; and
step S2, forming a reflective film on the surface having the grid points of the light guide plate body.

11. The method according to claim 10, wherein the reflective film is formed through a coating process in step S2.

12. The method according to claim 11, wherein the reflective film is made of terephthalic acid based polymers.

13. The method according to claim 10, wherein after step S2, the method further comprises step S3: curing the reflective film.

14. The method according to claim 13, wherein in step S3, the reflective film is cured by a curing process of ultraviolet radiation.

15. The method according to claim 10, wherein in step S1, the light guide plate body whose surface is provided with the grid points is manufactured with a hot rolling-embossing process or an ejection process.

16. The method according to claim 10, wherein the grid points are recesses or bulges formed on the surface of the light guide plate body.

17. The method according to claim 10, wherein an exterior surface of the reflective film is a plane.

18. The composite light guide plate according to claim 2, wherein an exterior surface of the reflective film is a plane.

19. The composite light guide plate according to claim 5, wherein an exterior surface of the reflective film is a plane.

20. The composite light guide plate according to claim 6, wherein an exterior surface of the reflective film is a plane.
